(19) United States
(12) Patent Application Publication
(10) Pub. No.: US 2014/0180782 A1
(43) Pub. Date: Jun. 26, 2014

(54) Techniques For Linking Consumers For Coupon Matching

(71) Applicants: Stuart Argue, Palo Alto, CA (US); Anthony Emile Marcar, San Francisco, CA (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/723,173

(22) Filed: Dec. 20, 2012

(51) Int. Cl. G06Q 30/02

(52) U.S. Cl. CPC G06Q 30/0239
USPC 705/14.16; 705/14.49

(57) ABSTRACT

A computer-implemented method is disclosed herein. The method includes the step of receiving, with a processing device of a commerce server, a shopping list containing a plurality of items from a primary consumer. The method also includes the step of controlling, with the processing device, a display of an electronic computing device of a secondary consumer to display the shopping list. The method also includes the step of receiving, with the processing device, a coupon list containing one more coupons from the secondary consumer wherein each of the one or more coupons corresponds to one of the plurality of items on the shopping list. The method also includes the step of transmitting, with the processing device, a message containing the coupon list to the primary consumer.

### BACKGROUND INFORMATION

1. Field of the Disclosure

The present invention relates generally to a peer-to-peer model for matching coupons to shopping lists.

2. Background

Coupons are made available by a merchant to provide shopping incentives in the form of discounts. In particular, coupons may offer discounts such as reducing the sale price by a fixed amount or reducing the sale price by a percentage. Coupons can also offer an indirect discount by discounting an additional item of the same type, such as buy one, get one half-off. Coupons are made available through a variety of media, such as newspapers, flyers, billboards, and websites. Consumers may selectively use these coupons on purchases to avail discounts.

It may be difficult to find and use all available coupons. Furthermore, there can be restrictions that limit the use of these coupons. For example, different coupon offers may not be used together for the same goods, only one coupon of each type may be used on a single purchase of a particular good, or a coupon may only be valid until a specific date. In addition, the coupons which may be used may only be valid at a particular location.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is an example schematic illustrating a system according to some embodiments of the present disclosure.

FIG. 2 is an example block diagram illustration of a commerce server that can be applied in some embodiments of the present disclosure.

FIG. 3 is an example screen shot of the display visible on a consumer's electronic computing device in an embodiment of the present disclosure.

FIG. 4 is an example screen shot of the display visible on a consumer's electronic computing device in an embodiment of the present disclosure.

FIG. 5 is an example flow chart illustrating a method that can be carried out according to some embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

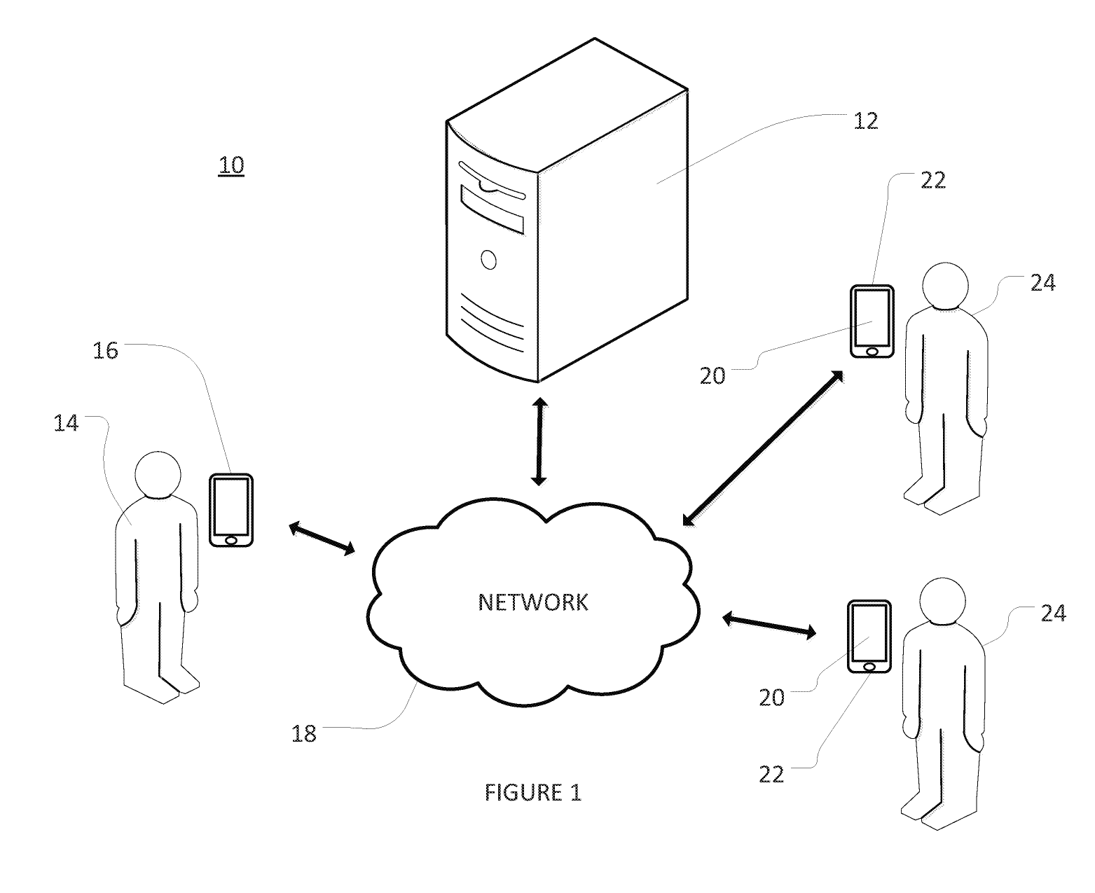

FIG. 1 is a schematic illustrating a coupon matching system 10 according to some embodiments of the present disclosure. The coupon matching system 10 can implement a computer-implemented method that includes the step of receiving, with a processing device of a commerce server 12, a shopping list containing a plurality of items from a primary consumer 14. The shopping list can be transmitted to the commerce server 12 from an electronic computing device 16 of the primary consumer 14. The electronic computing device 16 can be a laptop computer, a desktop computer, a smart-phone, a tablet, an e-reader, or any other electronic computing device operable to transmit a shopping list. The signal from the electronic computing device 16 and received by the commerce server 12 can be transmitted through a network 18. As used herein, the term “network” can include, but is not limited to, a Local Area Network (LAN), a Metropolitan Area Network (MAN), a Wide Area Network (WAN), the Internet, or combinations thereof. Embodiments of the present disclosure can be practiced with a wireless network, a hard-wired network, or any combination thereof.

The commerce server 12 can control a display 20 of an electronic computing device 22 of a secondary consumer 24 to display the shopping list generated by the primary consumer 14. The electronic computing device 22 can be a laptop computer, a desktop computer, a smart-phone, a tablet, an e-reader, or any other electronic computing device operable to transmit a shopping list. The secondary consumer 24 can access the shopping list and match items on the shopping list with available coupons.

The secondary consumer 24 can develop a coupon list of the coupons that are found to match the shopping list. The secondary consumer 24 can transmit the coupon list to the commerce server 12. The commerce server 12 can receive the coupon list containing one more coupons from the secondary consumer 24. Each of the one or more coupons corresponds to one of the plurality of items on the shopping list. The commerce server 12 can transmit a message containing the coupon list to the primary consumer 14.

It is noted that a particular consumer can be a primary consumer and secondary consumer. A particular consumer can submit his or her own shopping list to the commerce server and therefore define a primary consumer. Subsequently or concurrently or previously, the same, particular consumer can submit a coupon list to the commerce server to help another consumer and therefore define a secondary consumer.

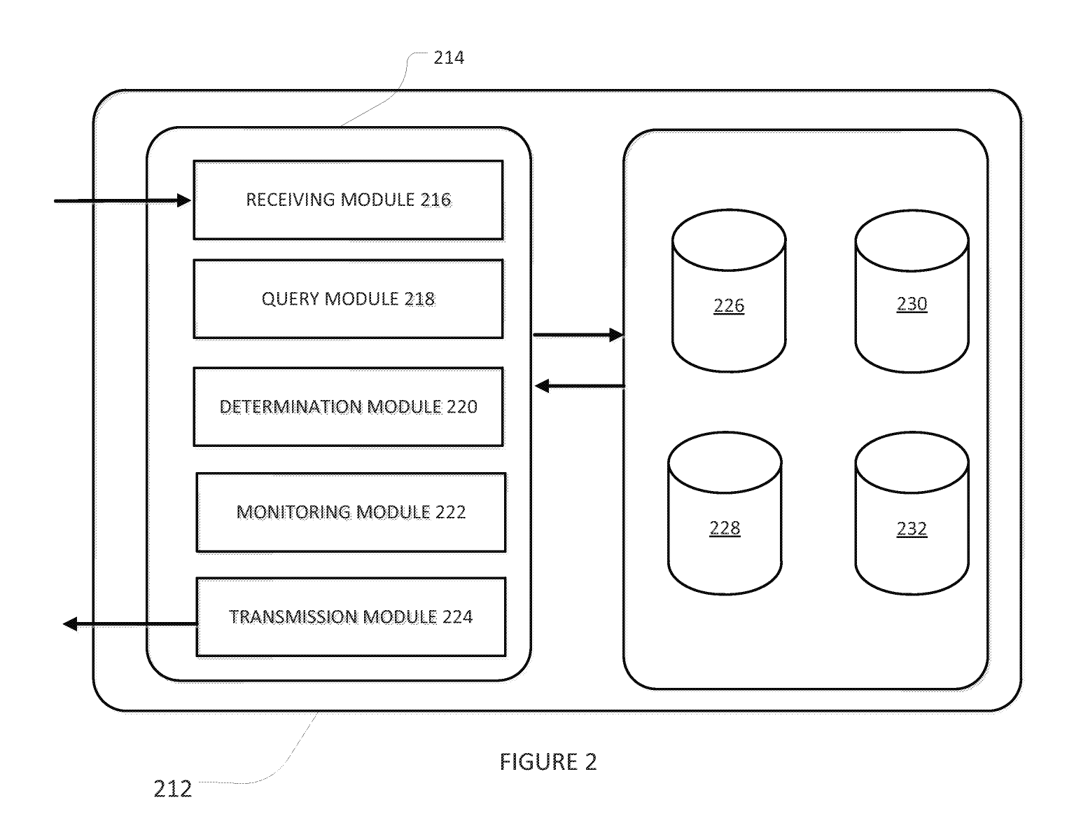

FIG. 2 is a block diagram illustrating a commerce server 212 according to some embodiments of the present disclosure. In the illustrated embodiment, the commerce server 212 can include a processing device 214 including a receiving module 216, a query module 218, a determination module 220, a monitoring module 222, and a transmission module 224. The commerce server 212 also includes a shopping list database 226, a coupon list database 228, a coupon database 230, and a reward database 232.

Any combination of one or more computer-usable or computer-readable media may be utilized in various embodiments of the disclosure. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

The shopping list database 226 can include memory containing one or more shopping lists generated by primary consumers. Each of the plurality of shopping lists can be correlated to a particular primary consumer. Each of the plurality of shopping lists can also be correlated to a particular time period. The primary consumer can indicate that the shopping trip to acquire the items on the shopping list is planned at some time in the future. For example, the primary consumer can create a shopping list and indicate that shopping is planned four hours in the future. The shopping list database 226 can store the shopping list with the four hour time period. The data in the shopping list database 226 can be organized based on one or more tables that may utilize one or more algorithms and/or indexes.

The coupon list database 228 can include memory containing coupon lists that are generated by secondary consumers. Each coupon list can include one or more coupons and each coupon applies to an item on the corresponding shopping list. Each of the plurality of coupon lists is correlated to a particular secondary consumer and to one of the plurality of shopping lists in the shopping list database 226. The coupon lists can be located within the coupon list database 228 and can be organized based on one or more tables that may utilize one or more algorithms and/or indexes.

The coupon database 230 can include memory containing a plurality of coupons. The coupons can be accessed by a secondary consumer as the secondary consumer generates a coupon list to match the primary consumer's shopping list. In some embodiments of the present disclosure, the secondary consumer can access coupons from other sources. For example, the secondary consumer can communicate a hyperlink on a coupon list. The coupons can be located within the coupon database 230 and can be organized based on one or more tables that may utilize one or more algorithms and/or indexes.

The reward database 232 can include memory containing rewards available to secondary consumers for matching coupons to the shopping lists of primary consumers. The secondary consumer can be credited with an economic reward, such as money, coupon(s), a rebate, or a gift card. The secondary consumer can be awarded a tangible prize, such as small appliance. The secondary consumer can be awarded a prize for being associated with the coupon list defining the largest amount of savings to the primary consumer. The reward database 232 can also include memory containing the history of activity of secondary consumers. For example, the reward database 232 can contain the amount of savings each particular secondary consumer has found for various primary consumers. Secondary consumers could also be awarded points for coupon matching activities and the reward database 232 can contain the number of points each particular secondary consumer has earned. Points could be redeemed by secondary consumers for tangible items or monetary awards. The data in the reward database 232 can be organized based on one or more tables that may utilize one or more algorithms and/or indexes.

The processing device 214 can communicate with the databases 226, 228, 230, 232. The processing device 214 can include computer readable memory storing computer readable instructions and one or more processors executing the computer readable instructions.

The receiving module 216 can be configured to receive a shopping list containing a plurality of items from a primary consumer. The receiving module 216 can also be configured to receive a coupon list containing one more coupons from a secondary consumer, wherein each of the one or more coupons corresponds to one of the plurality of items on the shopping list. The receiving module 216 can be operable to receive transmissions over the network 16 and then communicate the transmissions to other components of the commerce server 212. The receiving module 216 can direct a shopping list and associated time period that is received from a primary consumer to the shopping list database 226. The receiving module 216 can direct a coupon list that is received from a secondary consumer to the coupon list database 228.

The receiving module 216 can direct a query from a secondary consumer to the query module 218. A query can be a request for all unexpired shopping lists. The query module 218 can be configured to access all of the plurality of shopping lists in the shopping list database 226 in response to a request from a secondary consumer. The query module 218 can be configured to select from all of the plurality of shopping lists in the shopping list database 226 in response to the request from a secondary consumer. For example, the query module 218 can select one or more active shopping lists in the shopping list database 226 and direct those shopping lists to the secondary consumer.

The determination module 220 can be configured to determine a savings amount to the primary consumer in response to the coupon list received from the secondary consumer. The determination module 220 can receive the coupon list from the receiving module 216. The determination module 220 can calculate the cumulative savings the primary consumer would enjoy by applying the all of the coupons in the coupon list submitted by the secondary consumer. The amount of savings can be correlated to the coupon list in the coupon list database 228.

The monitoring module 222 can be configured to monitor the time periods stored in the shopping list database. In response to an expiration of one of the time periods, the monitoring module 222 can be operable to direct the transmission module 224 to transmit the expired shopping list to the primary consumer that generated that shopping list. The monitoring module 222 can communicate to the primary consumer that no coupon lists were submitted to the commerce server 212 if applicable. The monitoring module 222 can be operable to transmit any coupon lists that are correlated to the expired shopping list, if any coupon lists were submitted to the commerce server 212 by secondary consumers. The monitoring module 222 can be configured to select a single coupon list from among a plurality of coupon lists that were submitted by secondary consumers. The monitoring module 222 can be configured to select the coupon list with the largest amount of savings.

In some embodiments, the monitoring module 222 can be operable to direct the transmission module 224 to transmit more than one coupon list to the primary consumer, allowing the consumer to choose a desired coupon list. The use of coupons can be complicated by restrictions. Avoiding restrictions or manipulating a set of restrictions may be of greater value to the primary consumer than maximizing the amount of savings enjoyed on a particular shopping trip. Therefore, in some embodiments, more than one coupon list can be transmitted to the primary consumer to allow the consumer to choose a desired coupon list.

The transmission module 224 can be configured to transmit a message containing the coupon list to the primary consumer. The transmission module 224 can also be configured to transmit unexpired shopping lists contained in the shopping list database 226 to secondary consumers desiring to match coupons. The transmission module 224 can also be configured to transmit a message to a secondary consumer if the coupon list generated by the secondary consumer is communicated to the primary consumer; such a message can communicate that the secondary consumer has earned a reward.

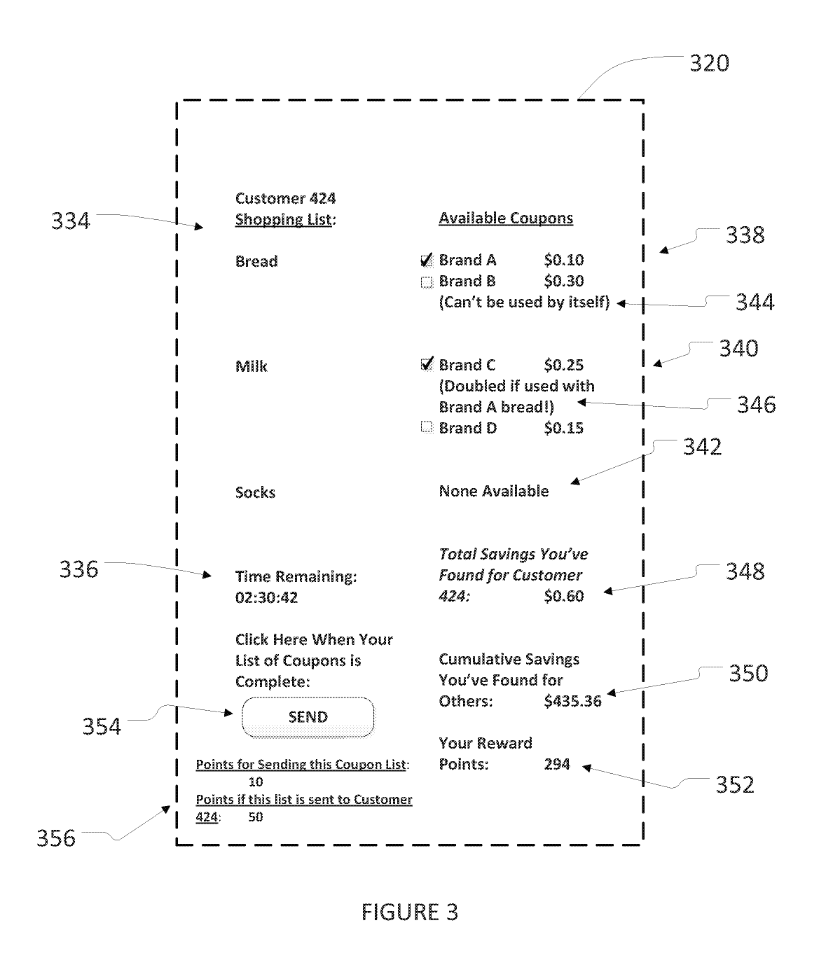

FIG. 3 illustrates a screen display that can be perceived by a secondary consumer in some embodiments of the present disclosure. FIG. 3 is a screen display 320 of an electronic computing device of a secondary consumer. The secondary consumer has received a shopping list 334 from the query module 218. The shopping list 334 is associated with a particular primary consumer, “Customer 424” in the exemplary display 320. The time remaining for submitting a coupon list is displayed at 336.

The secondary consumer has also been provided available coupons that match the primary consumer's shopping list 334. Two coupons available for bread are referenced at 338. Two coupons available for milk are referenced at 340. The secondary consumer has also been advised that no coupons are available for an item on the primary consumer's shopping list 334, at 342. When the secondary consumer has finalized the selection of coupons, a button 354 can be selected to communicate the resulting coupon list to the commerce server 212.

In the exemplary display 320, the secondary consumer has selected two coupons, marked by checked boxes in FIG. 3. It is noted that the selection of a group of coupons can be complicated by restrictions and bonuses. For example, some retailers limit the number of coupons that can be used per transaction. Coupon use can also be restricted among groups of products. Also, some coupons can offer bonuses for purchases of other products.

In some embodiments of the present disclosure, the restrictions associated with coupons in the coupon database 230 can be stored in the coupon database 230 and can be displayed to the secondary consumer. The secondary consumer can iteratively select groups of coupons until the cost savings of the group is maximized. FIG. 3 shows the display of coupon restrictions at 344 and a coupon bonus at 346. FIG. 3 also shows the display of the amount of savings achieved by the coupons presently selected at 348. The amount of savings can be stored with a coupon list in the coupon list database 228.

In some embodiments of the present disclosure, the matching of coupons can be incentivized. The matching of coupons can be managed as a game. Rewards, economic and in-kind, can be awarded to secondary consumers who engage in the game. FIG. 3 also shows the display of an incentive to transmit the coupon list at 356. FIG. 3 also shows that the secondary consumer can be advised of game performance. For example, the cumulative savings found by the secondary consumer for various primary consumers can be displayed at 350. In addition, the points awarded for the secondary consumer's efforts can be displayed at 352. By way of example and not limitation, the points earned by the secondary consumer can be redeemed for money, store credit, gift cards, or tangible items like small appliances, jewelry, and clothing.

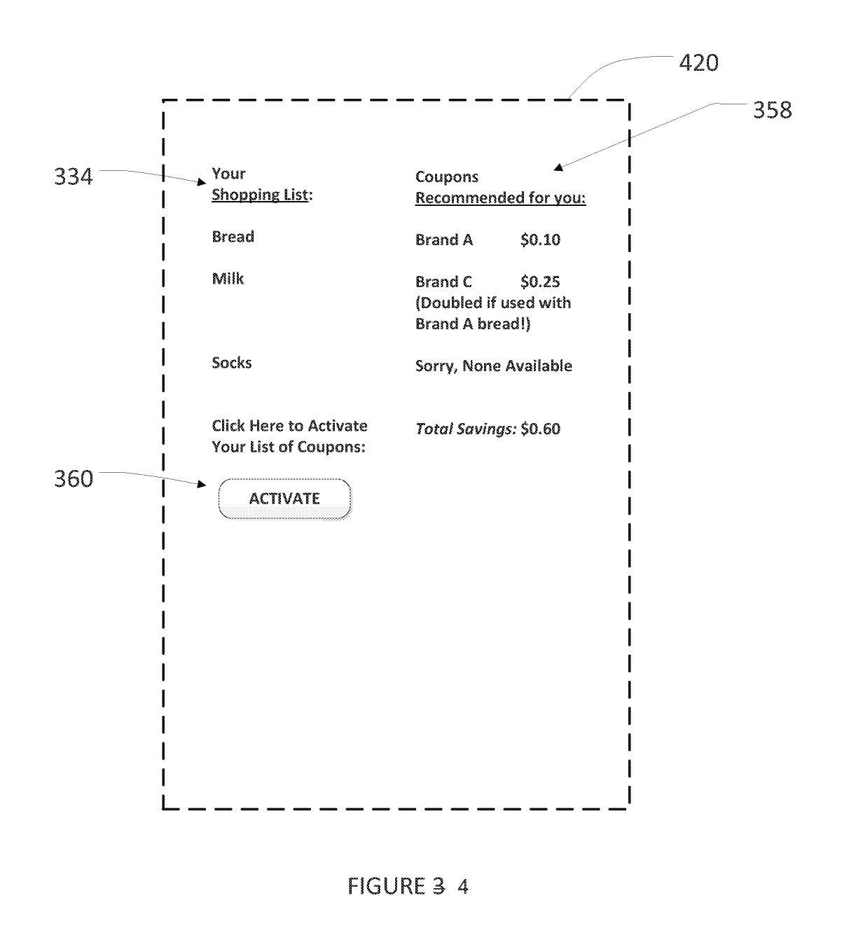

FIG. 4 illustrates a screen display that can be perceived by a primary consumer in some embodiments of the present disclosure. FIG. 4 is a screen display 420 of an electronic computing device of a primary consumer. The primary consumer can receive the shopping list 334 from the commerce server 212 when the time selected for the shopping list 334 expires.

The commerce server 212 may have received a coupon list containing one more coupons from a plurality of secondary consumers. Each coupon list can be saved in the coupon list database 228. Each coupon list can be correlated with an amount of savings. Upon the expiration of the shopping list 334, the determination module 220 can determine an optimal coupon list from the plurality of coupon lists stored in the coupon list database 220. The optimal coupon list can be the coupon list that defines the largest savings for the primary consumer from among the plurality of coupon lists. In some embodiments, the optimal coupon list can be defined differently. The optimal coupon list can be transmitted in a message to the primary consumer. FIG. 4 can be an exemplary message in some embodiments of the present disclosure.

FIG. 4 illustrates the display of the primary consumer's shopping list 334 and the coupon list 358 determined to be the optimal coupon list. If the primary consumer elects to accept the proposed coupon list 358, a button 360 can be selected to communicate the election to the commerce server 212. Upon the acceptance of the coupon list 358 by the primary consumer, the commerce server 212 can communicate a reward notification to the secondary consumer associated with the coupon list 358.

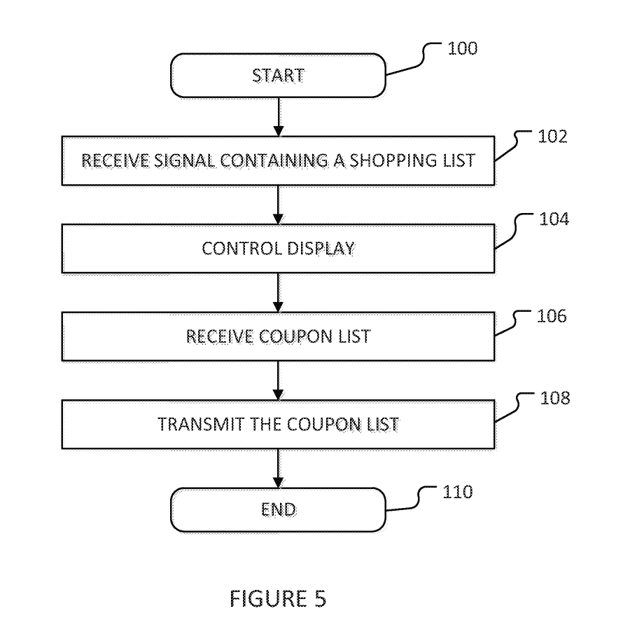

FIG. 5 is a flow chart illustrating a method that can be carried out in some embodiments of the present disclosure. The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The method starts at step 100. At step 102, the processor can receive a signal. The signal can be a shopping list containing a plurality of items from a primary consumer. At step 104, the commerce server 212 can control the displays of one or more electronic computing devices of secondary consumers to display the shopping list. Secondary consumers can request the shopping list in order to match coupons to the list. The commerce server 212 can thus control what is displayed to secondary consumers. The commerce server 212 can transmit the shopping list over a network.

At step 106, the commerce server 212 can receive a coupon list containing one more coupons from the secondary consumer. Each of the one or more coupons corresponds to one of the plurality of items on the shopping list. At step 108, the commerce server 214 can transmit a coupon list to the primary consumer. In some embodiments, the commerce server 212 can determine an optimal coupon list, such as the coupon list defining the largest amount of savings, from a plurality of coupon lists that are received and send only the optimal coupon list. In some embodiments, the commerce server 212 can send more than one coupon list. In some embodiments, the commerce server 212 can send all of the coupon lists that are received from secondary consumers. The exemplary method ends at step 110.

In some embodiments of the present disclosure, the secondary consumer can be given the opportunity to suggest changes to the primary consumer's shopping list through coupons to analogous products. For example, the secondary consumer can be permitted to suggest that the primary consumer purchase a different brand of soda based on the availability of coupon. The suggestion can be in the form of the coupon list that is submitted by the secondary consumer. The coupon list can include a coupon to a first brand or first product not included on the shopping list, but the first brand or product can be a reasonable substitute for a second brand or second product that is on the shopping list. In such embodiments, the primary consumer can be given the opportunity to indicate a degree of willingness to consider alternative products. This degree or level of willingness to consider alternative products can be communicated to the secondary consumer with the shopping list. The secondary consumer can thus be apprised if for example, the primary consumer is unwilling to consider analogous, alternative products prior to the secondary consumer creating a coupon list for the primary consumer.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

What is claimed is:

1. A computer-implemented method for linking consumers in a coupon matching game comprising the steps of:
receiving, with a processing device of a commerce server, a shopping list containing a plurality of items from a primary consumer;
controlling, with the processing device, a display of an electronic computing device of a secondary consumer to display the shopping list;
receiving, with the processing device, a coupon list containing one more coupons from the secondary consumer wherein each of the one or more coupons corresponds to one of the plurality of items on the shopping list; and
transmitting, with the processing device, a message containing the coupon list to the primary consumer.

2. The computer-implemented method of claim 1 wherein:
said controlling step further comprises controlling, with the processing device, the respective displays of electronic computing devices of a plurality of secondary consumers to display the shopping list of the primary consumer; and
said receiving step further comprises receiving, with the processing device, a coupon list containing one more coupons from at least one of the secondary consumers wherein each of the one or more coupons corresponds to one of the plurality of items on the shopping list.

3. The computer-implemented method of claim 2 wherein said receiving step further comprises:
receiving, with the processing device, a plurality of coupon lists each containing one more coupons from each from one of the plurality of the secondary consumers.

4. The computer-implemented method of claim 3 further comprising:
determining, with the processing device, an optimal coupon list that defines a largest savings for the primary consumer from among the plurality of coupon lists.

5. The computer-implemented method of claim 4 wherein said transmitting step further comprises:
transmitting, with the processing device, a message containing the optimal coupon list to the primary consumer.

6. The computer-implemented method of claim 4 further comprising:
communicating, with the processing device, a reward to the secondary consumer associated with the optimal coupon list.

7. The method of claim 1 further comprising:
controlling, with the processing device, the display of the electronic computing device of the secondary consumer to display an incentive to transmit the coupon list.

8. The method of claim 1 wherein said controlling step further comprises:
controlling, with the processing device, the display of the electronic computing device of the secondary consumer to display at least one coupon available for at least one of the plurality items on the shopping list.

9. The method of claim 8 wherein said controlling step further comprises:
controlling, with the processing device, the display of the electronic computing device of the secondary consumer to display a plurality of coupons available for at least one of the plurality items on the shopping list.

10. A commerce server comprising:
a processing device including:
a receiving module configured to receive a shopping list containing a plurality of items from a primary consumer and a coupon list containing one more coupons from a secondary consumer wherein each of the one or more coupons corresponds to one of the plurality of items on the shopping list; and
a transmission module configured to transmit a message containing the coupon list to the primary consumer.

11. The commerce server of claim 10 further comprising:
a shopping list database configured to store a plurality of shopping lists wherein each of the plurality of shopping lists is correlated to a particular primary consumer and a particular time period.

12. The commerce server of claim 11 wherein the processing device further comprises:
a query module configured to access all of the plurality of shopping lists in the shopping list database in response to a request from a secondary consumer.

13. The commerce server of claim 12 further comprising:
a coupon database configured to store a plurality of coupons.

14. The commerce server of claim 12 further comprising:
a coupon list database configured to store a plurality of coupon lists wherein each of the plurality of coupon lists is correlated to a particular secondary consumer and to one of the plurality of shopping lists in the shopping list database.

15. The commerce server of claim 14 wherein the processing device further comprises:
a determination module configured to determine a savings amount to the primary consumer in response to the coupon list received from the secondary consumer and to correlate the savings amount to the coupon list in the coupon list database.

16. The commerce server of claim 15 wherein the processing device further comprises:
a monitoring module configured to monitor the time periods stored in the shopping list database and, in response to an expiration of one of the time periods, operable to transmit to the primary consumer the expired shopping list and at least one coupon list that is correlated to the expired shopping list.

17. The commerce server of claim 16 wherein the monitoring module is configured to select the coupon list with a largest savings amount.

18. A computer-implemented method for linking consumers in a coupon matching game comprising the steps of:
receiving, with a processing device of a commerce server, a shopping list containing a plurality of items from a primary consumer;
controlling, with the processing device, respective displays of electronic computing devices of a plurality of secondary consumers to display the shopping list of the primary consumer;
receiving, with the processing device, a coupon list containing one more coupons from a plurality of the secondary consumers wherein each of the one or more coupons corresponds to one of the plurality of items on the shopping list;
determining, with the processing device, an amount of savings defined by each of the coupon lists; and
transmitting, with the processing device, a message containing the coupon list defining a largest amount of savings to the primary consumer.

19. The computer-implemented method of claim 18 further comprising:
crediting, with the processing device, an economic reward to the secondary consumer associated with the coupon list defining the largest amount of savings to the primary consumer.
